(19) United States
(12) Patent Application Publication
(10) Pub. No.: US 2007/0121251 A1
(43) Pub. Date: May 31, 2007

(54) Method of manufacturing head, head, and disk driving device

(75) Inventor: Kazuhiro Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/606,023

(22) Filed: Nov. 30, 2006

(30) Foreign Application Priority Data
Nov. 30, 2005 (JP) 2005-345911

(51) Int. Cl. G11B 5/60; G11B 17/32

(52) U.S. Cl. 360/236.3; 360/236.1

(57) ABSTRACT

According to one embodiment, a slider in a head has an opposite surface that is opposite a surface of a recording medium, a plurality of protrusions protrusively provided on the opposite surface, and a negative pressure cavity. A method of manufacturing a slider provides a mask of a predetermined shape on the opposite surface and then subjects the opposite surface to removing processing to form a protrusion including a protruding portion having two opposite sides. Another mask is provided on the opposite surface of the slider, the another mask covers one of the two opposite sides and a part of the protruding portion. Then, the opposite surface is subjected to removing processing to form a protruding portion in which the two adjacent sides are adjacent to respective grooves of different depths and which is narrower than the narrowest part of the masks used.

### CROSS-REFERENCE TO RELATED APPLICATIONS

This application is based upon and claims the benefit of priority from Japanese Patent Application No. 2005-345911, filed Nov. 30, 2005, the entire contents of which are incorporated herein by reference.

### BACKGROUND

1. Field

One embodiment of the invention relates to a method of manufacturing a head used in a disk driving device such as a magnetic disk driving device, a head manufactured by this manufacturing method, and a disk driving device comprising this head.

2. Description of the Related Art

A disk driving device, for example, a magnetic disk drive, comprises a magnetic disk disposed in a case, a spindle motor that supports and rotationally drives the magnetic disk, a magnetic head that reads and writes information from and to the magnetic disk, and a carriage assembly that supports the magnetic head so that the magnetic head is movable with respect to the magnetic disk. The carriage assembly comprises a pivotably supported arm and a suspension extending from the arm. The magnetic head is supported at an extending end of the suspension. The magnetic head has a slider attached to the suspension and a head portion provided in the slider. The head portion includes a reading element and a writing element.

The slider has a surface lying opposite a recording surface of the magnetic head, that is, ABS (Air Bearing Surface). A negative pressure cavity is formed in the opposite surface of the slider as a negative pressure generating section that generates a negative pressure. A predetermined head load acting toward a magnetic recording layer of the magnetic disk is imposed on the slider by the suspension. While the magnetic disk drive is in operation, air currents are generated between the rotating magnetic disk and the slider. The opposite surface of the slider is subjected to a positive pressure generated by the pad and to the negative pressure generated by the negative pressure cavity. By balancing the force applied by the air currents with the head load, the slider floats while maintaining a predetermined gap from the magnetic disk recording surface. This gap needs to be substantially equal at every radial position on the magnetic disk.

Exerting a negative pressure on the slider improves the characteristics of the slider. The improved characteristics allow a reduction in a margin (floating margin) for reduced pressure, error sensitivity, shock, and the like. This enables a normal magnetic spacing to be reduced to improve recording density.

The negative pressure is generated when air having passed through a thin air channel flows into a wider air channel. To achieve this, a protrusion is formed upstream of the vicinity of center of ABS of the slider so as to form a recessed portion that generates a negative pressure in the vicinity of center of ABS, that is, a negative pressure cavity.

The slider that generates a negative pressure is formed by such a removing processing as rests a protrusion on ABS. Such a slider has a complicated shape and thus cannot be produced simply by normal machining such as milling or grinding. To provide desired shapes, the slider is produced by removing processing such as ion milling or reactive ion etching (RIE) using masks obtained by patterning photo resist, as protective films.

As disclosed in, for example, Jpn. Pat. Appln. KOKAI Publication Nos. 10-177947, 2003-188088, and 2001-325707, a protrusion is produced on ABS by a process of photo resist patterning, removing processing, and photo resist removal. ABS of the desired shape is produced by repeating these processes of producing a protrusion a number of times with mask shape and removing processing depth varied.

In recent years, the improved recording density has reduced the size of sliders, and products such as what is called pico sliders and femto sliders have been developed. The reduced size of the slider reduces the width of the protrusion formed on ABS. However, an attempt to form a thin protruding pattern results in a thin mask pattern, which makes processing of the thin protruding pattern difficult. This is because the thin mask pattern makes the mask likely to be peeled off. If the mask is peeled off before or during removing processing, parts to be protected are exposed during the removing processing, preventing the desired shape from being obtained. The peeled-off mask may re-adhere to the machined surface. In this case, the mask protects undesired areas to prevent the desired shape from being obtained after the removing processing.

The mask size is limited and the minimum width is 30 μm. When such a mask is used, the disk opposite surface of the slider has a minimum pattern width of 30 μm. The requirement for the slider pattern to have a width of at least 30 μm has reduced the degree of freedom of design to degrade the characteristics of the slider. The absolute value of a negative pressure generated by the slider increases consistently with the area of the negative pressure generating section. Thus, the larger width of protrusion on ABS reduces the area of the negative pressure generating section. This degrades the head characteristics.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary plan view showing a hard disk drive (hereinafter referred to as an HDD) according to a first embodiment of the present invention;

FIG. 2 is an exemplary enlarged side view showing a magnetic head portion of the HDD;

FIG. 3 is an exemplary perspective view showing a disk opposite surface side of a slider in the magnetic head;

FIGS. 4A and 4B are an exemplary plan view showing the disk opposite surface side of the slider and an exemplary diagram showing patterns corresponding to respective heights;

FIG. 5 is an exemplary sectional view showing the slider and taken along line V-V in FIG. 4;

FIG. 6 is an exemplary perspective view showing a recess and protrusion structure manufactured by a basic manufacturing method according to the first embodiment;

FIG. 7 is an exemplary plan view showing a manufacturing step of the basic method;

FIG. 8 is an exemplary plan view showing a manufacturing step of the basic method;

FIGS. 9A, 9B, 9C, 9D, 9E, and 9F are exemplary sectional views showing respective manufacturing steps of the basic method;

FIG. 10 is an exemplary plan view of a slider showing a first removing processing of the manufacturing method according to the first embodiment;

FIG. 11 is an exemplary plan view of the slider showing a second removing processing of the manufacturing method according to the first embodiment;

FIG. 12 is an exemplary plan view of the slider showing a third removing processing of the manufacturing method according to the first embodiment;

FIGS. 13A, 13B, 13C, 13D, and 13E are exemplary plan views showing plural types of sliders manufactured by the manufacturing method according to the first embodiment and plural types of sliders according to comparative examples;

FIG. 14 is an exemplary diagram showing the relationship between the width of protruding portion of each of the plural types of sliders and a negative pressure generated;

FIG. 15 is an exemplary perspective view showing a magnetic head according to a second embodiment of the present invention;

FIGS. 16A, 16B, and 16C are exemplary plan views showing respective steps of manufacturing a magnetic head according to the second embodiment;

FIG. 17 is an exemplary perspective view showing a magnetic head according to a third embodiment of the present invention;

FIGS. 18A, 18B, and 18C are exemplary plan views showing respective steps of manufacturing a magnetic head according to the third embodiment;

FIG. 19 is an exemplary perspective view showing a magnetic head according to a fourth embodiment of the present invention; and

FIGS. 20A, 20B, and 20C are exemplary plan views showing respective steps of manufacturing a magnetic head according to the fourth embodiment.

### DETAILED DESCRIPTION

Various embodiments according to the invention will be described hereinafter with reference to the accompanying drawings. In general, according to an aspect of the invention, there is provided a method of manufacturing a head comprising a slider including an opposite surface which is opposite a surface of a rotatable recording medium and which has a plurality of protrusions and a negative pressure cavity, the slider being configured to maintain a fixed gap between the opposite surface and the recording medium surface by air currents generated between the recording medium surface and the opposite surface by rotation of the recording medium, and a head portion provided on the slider to read and record information from and to the recording medium, the method comprising:

providing a mask having a predetermined shape on the opposite surface of the slider and then subjecting the opposite surface to removing processing to form a protrusion including a protruding portion having two opposite sides; and providing another mask on the opposite surface of the slider, the another mask covering one of the two opposite sides and a part of the protruding portion, and then subjecting the opposite surface to removing processing to form a protruding portion in which the two opposite sides are adjacent to respective grooves of different depths and which is narrower than the narrowest part of the masks used.

According to another aspect of the invention, there is provided a head manufactured by the manufacturing method, the head comprising:

a slider having the opposite surface; a leading step and a pair of side steps formed on the opposite surface of the slider, each constituting the protrusion; and a negative pressure cavity defined by the leading step and pair of side steps, an end portion of each of the side steps which is positioned downstream with respect to the air currents constituting the protruding portion.

According to still another aspect of the invention, there is provided a disk driving device comprising: a disk-shaped recording medium; a driving section which supports and rotates the recording medium; the head according to claim 2 comprising a slider including an opposite surface which is opposite a surface of the recording medium and which maintains a fixed gap between the opposite surface and the recording medium surface via air currents generated between the recording medium surface and the opposite surface by rotation of the recording medium, and a head portion provided in the slider to record and reproduce information on and from the recording medium; and a head suspension which supports the head so that the head is movable with respect to the recording medium and which imposes a head load acting toward the surface of the recording medium, on the head.

With reference to the drawings, a detailed description will be given of a method of manufacturing a magnetic head, and HDD serving as disk driving devices and comprising the magnetic head manufactured by the manufacturing method, according to an embodiment of the present invention.

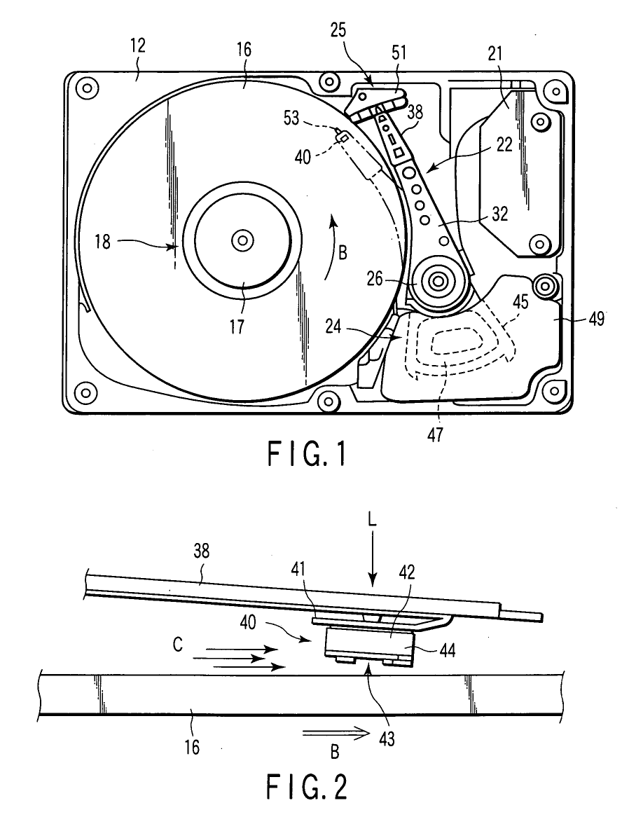

First, HDD will be described. FIG. 1 is a plan view of HDD from which a top cover has been removed to show its internal structure. FIG. 2 shows a floating magnetic head. As shown in FIG. 1, HDD has a case 12 shaped like a rectangular box and having an opened top, and the top cover (not shown) threadably fitted on the case with a plurality of screws to close the upper end opening in the case.

The case 12 contains a magnetic disk 16 serving as a recording medium, a spindle motor 18 serving as a driving section that supports and rotates the magnetic disk, a plurality of magnetic heads that write and read information to and from the magnetic disk, a carriage assembly 22 that supports these magnetic heads so that the magnetic heads are movable with respect to the magnetic disk 16, and a voice coil motor (hereinafter referred to as VCM) 24 that rotates and positions the carriage assembly. The case 12 also contains a ramp load mechanism 25 that holds each magnetic head at a retreated position located away from the magnetic disk after the magnetic head has moved to an outer periphery of the magnetic disk 16, and a circuit board unit 21 having a head IC and the like.

A printed circuit board is screwed to an outer surface of a bottom wall of the case 12 via the circuit board unit 21 to control the operation of the spindle motor 18, VCM 24, and magnetic head.

The magnetic disk 16 has a magnetic recording layer on a top surface and on a bottom surface. The magnetic disk 16 is fitted around an outer periphery of hub (not shown) of the spindle motor 18 and fixed on the hub by a cramp spring 17. Driving the spindle motor 18 rotates the magnetic head 16 at a predetermined rotation speed, for example, 4,200 rpm in the direction of arrow B.

The carriage assembly 22 comprises a bearing portion 26 fixed on the bottom wall of the case 12, and a plurality of arms 32 extending from the bearing portion. These arms 32 are positioned parallel to the surface of the magnetic disk 16 at predetermined intervals and extend from the bearing portion 26 in the same direction. The carriage assembly 22 includes elastically deformable suspensions 38 shaped like an elongate plate. Each suspension 38 is formed of, for example, a leaf spring. The suspension 38 has a base end fixed to a leading end of the arm 32 by spot welding, adhesion, or caulking, and extends from the arm. Each suspension 38 may be integrated with the corresponding arm 32. The arm 32 and suspension 38 constitute a head suspension. The head suspension and the magnetic head constitute a head suspension assembly.

As shown in FIG. 2, each magnetic head 40 has a slider 42 formed in a substantially rectangular parallelepiped and a recording and reproducing head portion 44 provided in the slider. The magnetic head 40 is fixed to a gimbal spring 41 provided at a leading end of the suspension 38. The elasticity of the suspension 38 imposes a head load L acting toward a surface of the magnetic disk 16, on each magnetic head 40.

As shown in FIG. 1, the carriage assembly 22 includes a support frame 45 extending from the bearing portion 26 in a direction opposite to that of the arm 32. The support frame 45 supports a voice coil 47 partly constituting VCM 24. The support frame 45 is formed of a synthetic resin around an outer periphery of the voice coil 47 integrally with the voice coil 47. The voice coil 47 is positioned between a pair of yokes 49 fixed to the case 12. The voice coil 47 constitutes VCM 24 together with the yokes 49 and a magnet (not shown) fixed to one of the yokes. The carriage assembly 22 is rotated by energizing the voice coil 47, and the magnetic heads 40 move to desired tracks of the magnetic disk 16 and are positioned on the tracks.

The ramp load mechanism 25 comprises a ramp 51 provided on the bottom wall of the case 12 and placed outside the magnetic disk 16, and a tab 53 extending from the leading end of each suspension 38. When the carriage assembly 22 rotates to the retreated position outside the magnetic disk 16, each tab 53 engages with a ramp surface formed on the ramp 51. The tab 53 is then raised by the inclination of the ramp surface to unload the magnetic head 40.

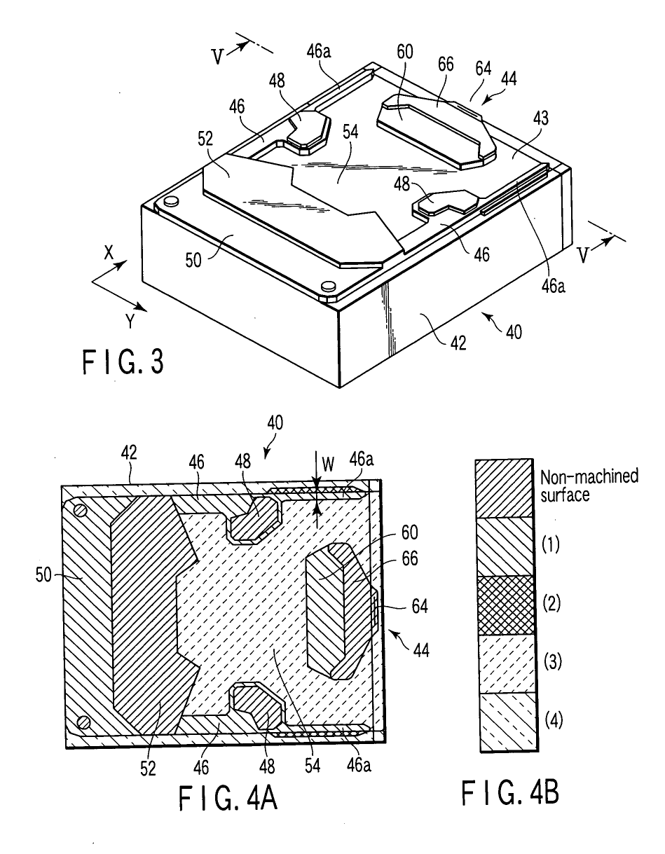

Now, the configuration of the magnetic head 40 will be described in detail. FIG. 3 is a perspective view showing the magnetic head. FIG. 4A is a plan view of the slider. In FIG. 4A, various hatchings indicate different depths in order to clarify areas of these depths in the disk opposite surface of the slider. For example, as shown in FIG. 4B, a hatching (1) indicates a non-machined surface and hatchings (2), (3), (4), and (5) indicate areas of depth 120 nm, 320 nm, 1.32 μm, and 1520 μm, respectively, from the non-machined surface.

As shown in FIGS. 2 to 4A, the magnetic head 40 has a slider 42 formed in a shape of a substantially rectangular parallelepiped. The slider 42 has a rectangular disk opposite surface (ABS) lying opposite the surface of the magnetic disk 16. A longitudinal direction of the disk opposite surface 43 is defined as a first direction X. A width direction perpendicular to the first direction is defined as a second direction Y.

The magnetic head 40 is configured to be a floating type head. The slider 42 flies owing to air currents C generated between the disk surface and the disk opposite surface 43 by rotation of the magnetic disk 16. While HDD is in operation, the disk opposite surface 43 of the slider 42 always lies opposite the disk surface with a gap maintained between the surfaces. The direction of the air currents C coincides with the direction B of rotation of the magnetic disk 16. The slider 42 is placed with respect to the surface of the magnetic disk 16 so that the first direction X of the disk opposite surface 43 substantially coincides with the direction of the air currents C.

A substantially rectangular leading step portion 50 is protrusively provided on the disk opposite surface 43 opposite the magnetic disk surface. The leading step portion 50 is formed over an upstream area of the disk opposite surface 43 with respect to the direction of the air currents C. A pair of elongate side step portions 46 is protrusively formed on the disk opposite surface 43 and extend from the leading step portion 50 to a downstream end of the slider 42. The side step portions 46 extend along the respective long sides of the disk opposite surface 43 and lie opposite each other at a certain interval. The leading step portion 50 and the pair of side step portions 46 constitute a generally U-shaped protrusion which is closed on the upstream side and is open toward the downstream side.

To maintain the pitch angle of the magnetic head 40, a leading pad 52 is protrusively provided on the leading step portion 50 to support the slider 42 via an air film. The leading pad 52 extends continuously over the width direction of the leading pad 52 in the second direction Y. The leading pad 52 is provided at a position slightly shifted on the downstream side from the upstream side end, i.e., a flow-in side end of the slider 42 with respect to the air currents C. A side pad 48 is protrusively provided on a central part of each side step 46 in the longitudinal direction. The leading pad 52 and side pads 48 are formed substantially flat and opposite the magnetic disk surface.

A negative pressure cavity 54 is formed in a substantially central part of the disk opposite surface 43. The negative pressure cavity 54 is formed of a recess defined by the pair of side step portions 46 and the leading step portion 50. The negative pressure cavity 54 is formed on the downstream side of the leading step portion 50 with respect to the direction of the air currents C and open toward the downstream side. The negative pressure cavity 54 allows a negative pressure to be generated in the central part of the disk opposite surface 43 at all skew angle realized in HDD.

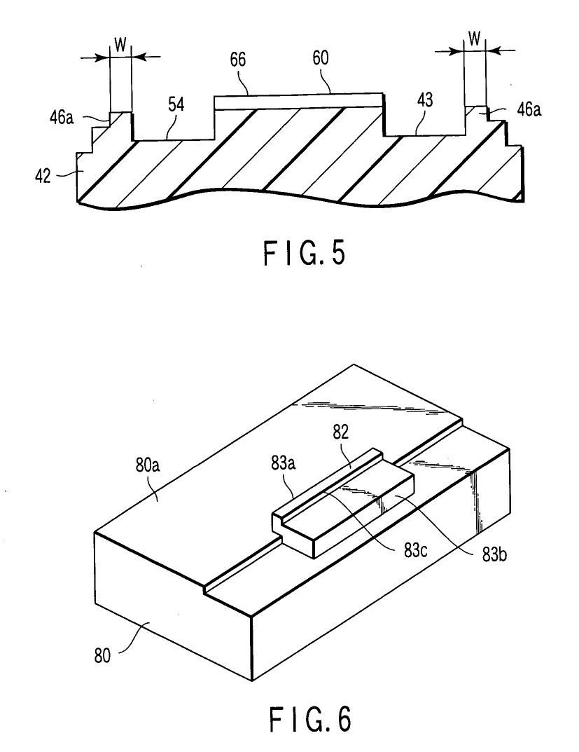

An end of each side step 46 located downstream with respect to the air currents C forms a protruding portion 46A more elongate than the other portions of the side step. As shown in FIGS. 3 to 5, each protruding portion 46A has two sides extending in the longitudinal direction X and opposite each other. As described below, these two sides are formed by subjecting the disk opposite surface 43 to removing processing and are adjacent to grooves of different depths. For example, one of sides of the protruding portion 46A is adjacent to the negative pressure cavity 54. The other side is adjacent to the groove shallower than the negative pressure cavity. The width W of each protruding portion 46A is formed in, for example, 30 μm or less, which is smaller than the minimum width of a mask used for a removing processing.

The slider 42 has a substantially rectangular trailing step portion 60 protrusively provided at the downstream end of the disk opposite surface 43 with respect to the direction of the air currents C. The trailing step portion 60, constituting a protrusion, is positioned downstream of the negative pressure cavity 54 and substantially in the center of the disk opposite surface 43 across the width. A trailing pad 66 is protrusively provided over the trailing step portion 60 and opposite the magnetic disk surface.

A head portion 44 of the magnetic head 40 has a recording element and a reproducing element which record and reproduce information on and from the magnetic disk 16. The reproducing element and recording element are buried in the downstream end of the slider 42 with respect to the direction of the air currents C. The reproducing element and recording element have a read/write gap 64 formed in the trailing pad 66.

As shown in FIG. 2, the magnetic head 40 configured as described above flies in an inclined state such that the read/write gap 64 in the head portion 44 is closest to the magnetic disk surface.

Now, description will be given of a method of manufacturing the magnetic head in HDD configured as described above. Here, description will be given of a method of forming the disk opposite surface 43 of the slider 42 into a desired recessed and protruding shape.

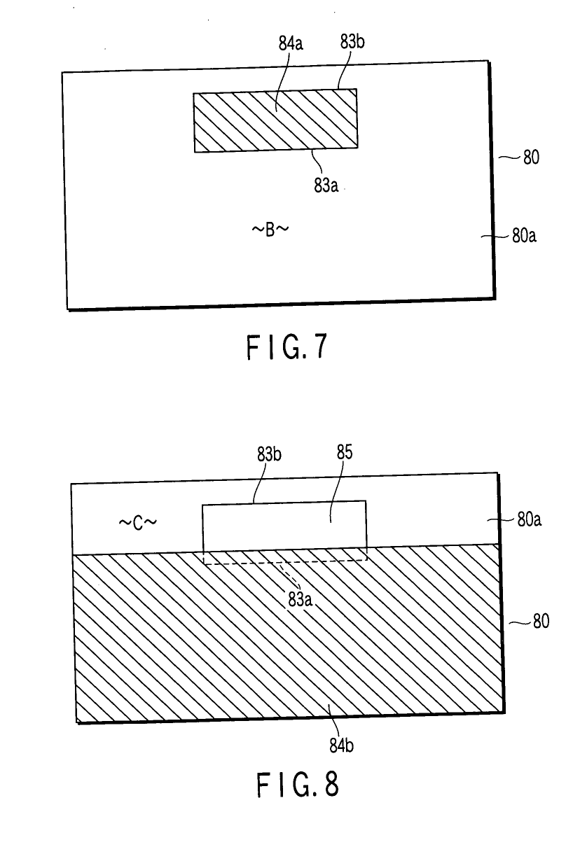

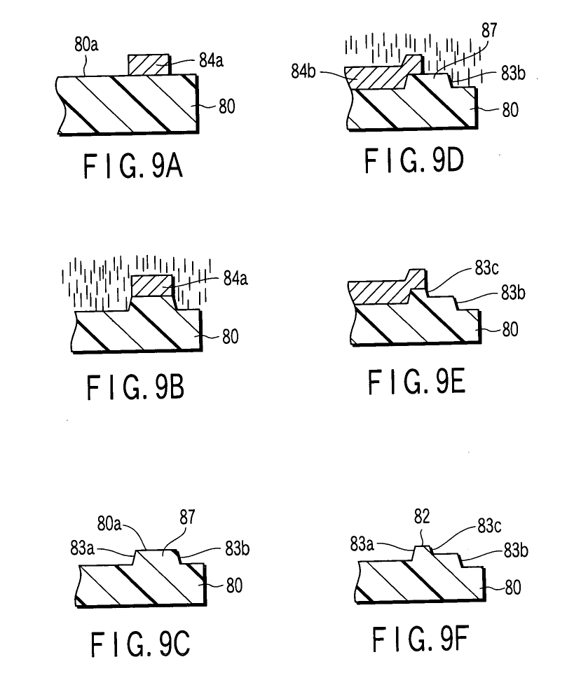

First, a basic method will be described in which an elongate protruding portion 82 having width of 30 μm or less is formed on one surface 80a of a rectangular parallelepiped 80. As shown in FIGS. 7 and 9A, photo resist is coated on the surface 80a of the rectangular parallelepiped 80 and exposed and developed to form a first mask 84a of a predetermined shape, for example, a rectangle. The diagonally shaded areas in FIGS. 7 and 8 represent the first mask 84a and a second mask 84b. The width of the first mask 84a is formed to be sufficiently larger than 30 μm. Under these conditions, as shown in FIGS. 7 and 9B, an area B of the surface 80a which is not protected by the first mask 84a is removed by ion milling or reactive ion etching (RIE) to form a groove of a predetermined depth. The first mask 84a is subsequently removed. Thus, as shown in FIG. 9C, a rectangular protrusion corresponding to the first mask 84a, that is, the protrusion 87 having two opposite sides 83a and 83a, is formed on the surface 80a.

Subsequently, as shown in FIGS. 8 and 9D, a second mask 84b is formed on the surface 80a of the rectangular parallelepiped 80. The width of the second mask 84b is sufficiently larger than 30 μm. The second mask 84b covers a predetermined-width area of a protrusion 87 which includes one side 83a of the protrusion 87 and a predetermined area of the surface 80a. The area of the protrusion 87 which is covered with the second mask 84b has a width of 30 μm or less and corresponds to the protruding portion 82.

Under these conditions, as shown in FIGS. 8 and 9D, an area C of the surface 80a and protrusion 87 which is not covered with the second mask 84b is removed by ion milling or RIE to form a groove of a predetermined depth as shown in FIG. 9E. The second mask 84a is subsequently removed. Thus, as shown in FIGS. 9F and 6, the deepest groove is formed in the area C of the surface 80a which has been subjected to the second removing processing. The protrusion 87 is partly removed to form a thin protruding portion 82 of width smaller than 30 μm which corresponds to the second mask 84. The protruding portion 82 has two opposite sides 83a and 83c adjacent to grooves of different depths. The side 83a is adjacent to the groove formed by the first removing processing, and the other side 83c is adjacent to the shallower groove formed by the second removing processing.

The above method enables a protruding portion 82 having a width of 30 μm or less to be formed using a mask with a width of 30 μm or more in the smallest part.

Now, description will be given of a method of forming the disk opposite surface 43 of the slider 42 into the desired recessed and protruding shape using the above basic method.

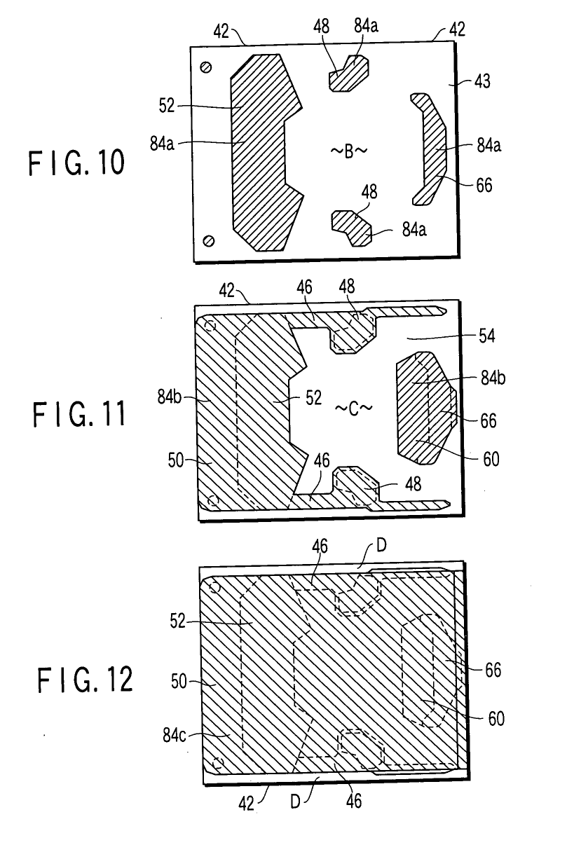

First, as shown in FIG. 10, a first mask 84a is formed on the disk opposite surface 43 of the slider 42, and the first mask 84a has a shape corresponding to the leading pad 52, side pads 48, and trailing pad 66. The width of smallest part of the first mask 84a is sufficiently larger than 30 μm. Under these conditions, an area B of the disk opposite surface 43 which is not protected by the first mask 84a is removed by ion milling or RIE to form a groove of a predetermined depth, for example, 120 nm. The first mask 84a is subsequently removed. This forms a leading pad 52, side pads 48, and a trailing pad 66 on the disk opposite surface 43. The surfaces of the leading pad 52, side pads 48, and trailing pad 66 are non-machined surfaces that are not subjected to removing processing.

Subsequently, as shown in FIG. 11, a second mask 84b is formed on the disk opposite surface 43 of the slider 42, the second mask 84b has a shape corresponding to the leading step 50, pair of side steps 46, and trailing step 60. The width of smallest part of the second mask 84b is formed to be sufficiently larger than 30 μm. Under these conditions, the area C of the disk opposite surface 43 which is not protected by the second mask 84b is removed by ion milling or RIE. The area C overlaps the area B subjected to the first removing processing. Correspondingly, a groove of a predetermined depth, for example, 200 nm is formed. The second mask 84b is subsequently removed. This forms a leading step 50, a pair of side steps 46, a trailing step 60, and a negative pressure cavity 54.

Then, third removing processing is executed to form elongate protruding portions 46A at the downstream ends of the side steps 46. In this case, as shown in FIG. 12, a third mask 84c is formed on the disk opposite surface 43 of the slider 42, the third mask 84c covers the leading step 50, pair of side steps 46, trailing step 60, and negative pressure cavity 54. The third mask 84c is formed to cover an area of downstream end of each side step 46 which corresponds to one side of the downstream end facing the negative pressure cavity 54 and to substantially half of the downstream end in the width direction, that is, the area having a width of 30 μm or less. The width of smallest part of the third mask 84c is formed to be sufficiently larger than 30 μm.

Under these conditions, an area D of the disk opposite surface 43 and downstream end of each side step 46 which is not protected by the third mask 84c is removed by ion milling or RIE to form a groove of a predetermined depth. The third mask 84c is subsequently removed. Thus, as shown in FIGS. 3 and 4, the deepest groove, for example, a groove of depth 1200 nm, is formed in areas D of opposite side edges of the disk opposite surface 34 subjected to the three removing processes. The downstream end of each side step 46 is partly removed to form a thin protruding portion 46a of width smaller than 30 μm which corresponds to the third mask 84c. Each protruding portion 46a has two opposite sides adjacent to the respective grooves of different depths. One of the sides is adjacent to the negative pressure cavity 54, and the other side is adjacent to the shallower groove formed by the three removing processes.

The method of manufacturing the head configured as described above enables a protruding portion having a width of 30 μm or less to be formed using a mask with a minimum width of 30 μm or more. This increases the degree of freedom of design of the recess and protrusion shape of the disk opposite surface regardless of minimum width of the protruding portion. A high-performance magnetic head can thus be produced. Further, the width of the side step can be set at a small value of 30 μm or less, allowing the area of the negative pressure cavity to be increased. This enables a slider with an increased negative pressure to be implemented. That is, the slider has improved characteristics.

The above manufacturing method also enables fine protruding patterns to be formed on a disk opposite surface that is small in area. This is effective in manufacturing small-sized sliders such as femto sliders. Constructing HDD using a thus configured magnetic head enables the implementation of HDD with improved stability and reliability.

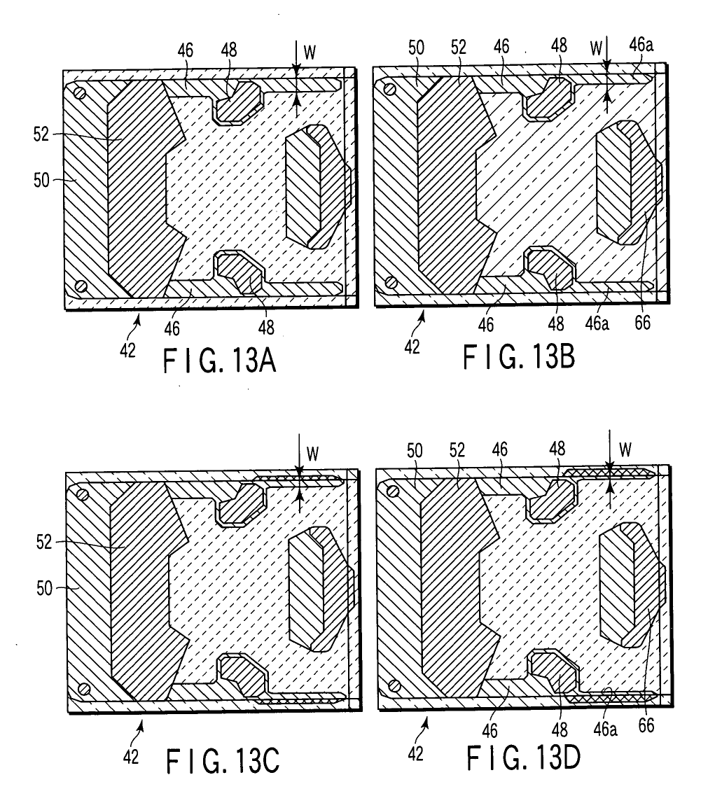

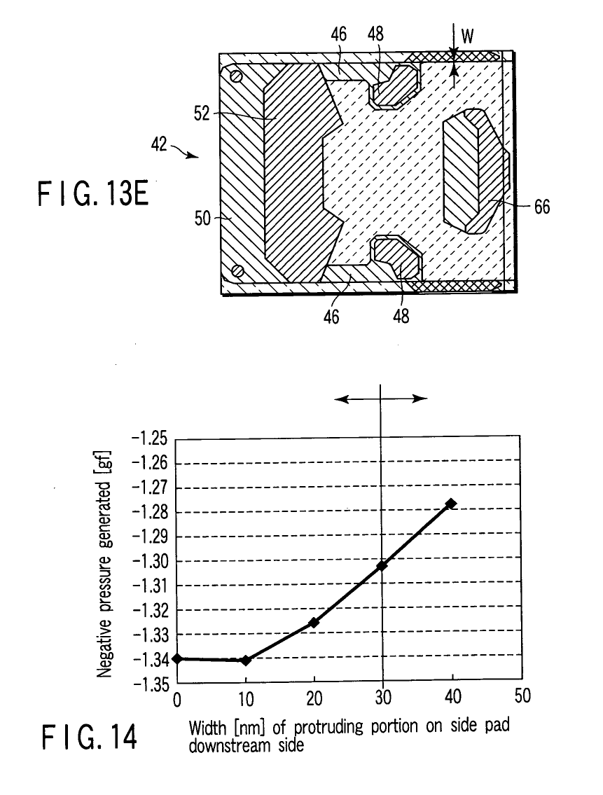

As shown in FIGS. 13A, 13B, 13C, 13D, and 13E, the present inventor prepared five types of sliders 42 formed so that the protruding portion 46a of the side step 46 had a width W of 40 μm, 30 μm, 20 μm, 10 μm, or 0 μm. The present inventor thus analyzed the relationship between the width of the protruding portion and generation of a negative pressure. FIGS. 13C, 13D, and 13E show sliders manufactured by the manufacturing method according to the above embodiment. The analysis is shown in Table 1 and FIG. 14.

TABLE 1

| | Width [μm] of protruding portion | | | | |
|---|---|---|---|---|---|
| | on side pad downstream side | | | | |
| | Comparative example | | Present embodiment | | |
| | 40 | 30 | 20 | 10 | 0 |
| Negative pressure | −1.28 | −1.30 | −1.33 | −1.34 | −1.34 |
| generated [gf] | | | | | |

Analysis conditions were as follows.

Disk rotation speed: 4,200 rpm

Disk radius: 25 mm

Skew angle: 0 deg

Head load: 2 gf

Pitch moment: 0.57 gfmm

The table and FIG. 14 show that as the width of the protruding portion 46a decreases to 20 μm and then to 10 μm, a negative pressure generated increases compared to that generated when the width is 30 μm or more. That is, a higher negative pressure is generated by the slider having a narrower protruding portion which can be produced according to the present embodiment.

On the other hand, the above mentioned manufacturing method executes two removing processes to form a protruding portion and thus requires two mask alignments. Mask alignment tolerance is about 5 μm. Two removing processes may result in a maximum misalignment of 10 μm. Thus, the minimum width of the protruding portion formed is determined by the alignment precision of the mask. The minimum width is double a single alignment tolerance. The minimum width is estimated to be 10 μm with a normal alignment technique. However, as shown in the table and FIG. 14, the analysis indicates that the effect of an increase in negative pressure varies insignificantly regardless of whether the width of the protruding portion is 10 μm or 0 μm.

Now, description will be given of a magnetic head of HDD according to a second embodiment of the present invention.

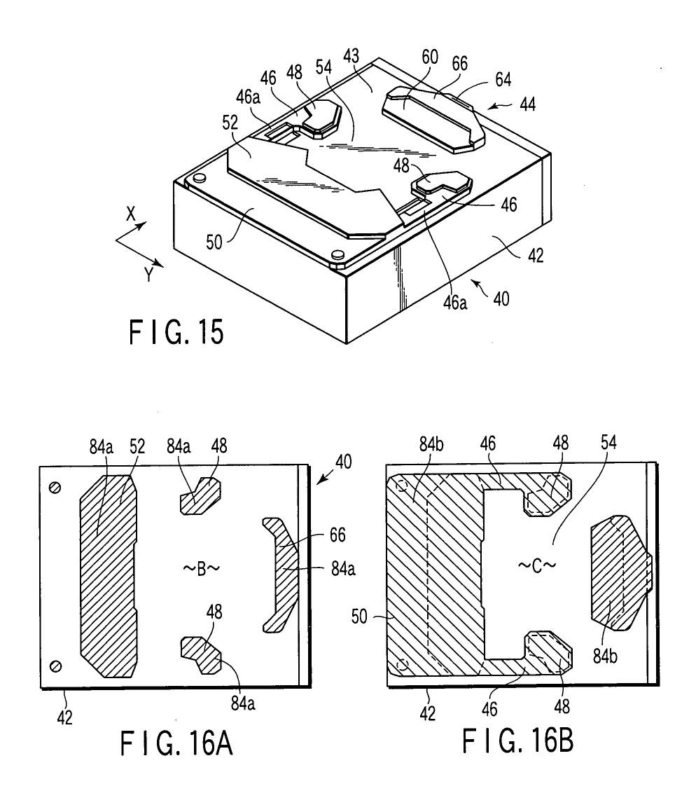

As shown in FIG. 15, according to the second embodiment, the leading step 50, pair of side steps 46, and trailing step 60 are formed on the disk opposite surface 43 of the slider 42; the leading step 50, pair of side steps 46, and trailing step 60 each constitute a protrusion. The leading pad 52, side pad 48, and trailing pad 66 are formed on the leading step 50, side step 46, and trailing step 60, respectively.

In each side step 46, the protruding portion 46a more elongate than the other portions of the side step is formed between the leading pad 52 and the side pad 48. Each protruding portion 46a has two sides extending along the longitudinal direction X and opposite each other. These two sides are formed by subjecting the disk opposite surface 43 to removing processing and are adjacent to grooves of different depths. The width W of each protruding portion 46a is formed to be 30 μm or less, for example, which is smaller than the minimum width of a mask used for a removing process.

In the second embodiment, the other arrangements of the magnetic head are the same as those in the first embodiment. The same parts are denoted by the same reference numerals and their detailed description is omitted.

Now, description will be given of a method of manufacturing a magnetic head configured as described above, here, a method of forming the disk opposite surface 43 of the slider 42 into a desired recess and protrusion shape.

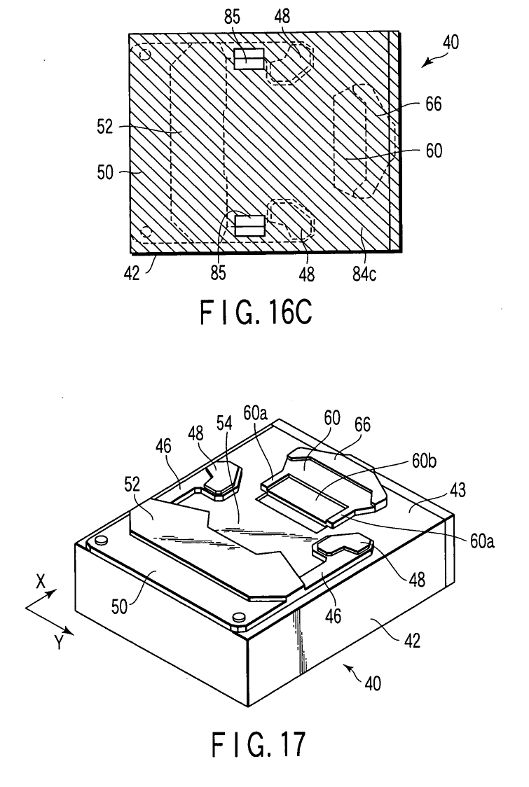

As is the case with the first embodiment, as shown in FIG. 16A, the first mask 84a is formed on the disk opposite surface 43 of the slider 42; the first mask 84a has a shape corresponding to the leading pad 52, side pad 48, and trailing pad 66. The area B of the disk opposite surface 43 which is not protected by the first mask 84a is removed by ion milling or RIE to form a groove of a predetermined depth, for example, 120 nm. The first mask 84a is subsequently removed. This forms a leading pad 52, side pads 48, and a trailing pad 66 on the disk opposite surface 43.

Subsequently, as shown in FIG. 16B, the second mask 84b is formed on the disk opposite surface 43 of the slider 42; the second mask 84b has a shape corresponding to the leading step 50, pair of side steps 46, and trailing step 60. The width of smallest part of the second mask 84b is formed to be sufficiently larger than 30 μm. Under these conditions, the area C of the disk opposite surface 43 which is not protected by the second mask 84b is removed by ion milling or RIE. The second mask 84b is subsequently removed. This forms a leading step 50, a pair of side steps 46, a trailing step 60, and a negative pressure cavity 54.

Then, third removing processing is executed to form elongate protruding portions 46A in intermediate portions of the side steps 46. In this case, as shown in FIG. 16C, the third mask 84c is formed to cover the entire disk opposite surface 43 of the slider 42. A pair of rectangular openings 85 is formed in the third mask 84c. Each opening 85 is located opposite one side of the intermediate portion of the side step 46 facing the negative pressure cavity 54 and also opposite a part of the intermediate portion in the width direction. Thus, the third mask 84c covers a part of the intermediate portion which corresponds to one side of it lying opposite the negative pressure cavity 54 and to an area of width at most 30 μm.

Under these conditions, an area of the disk opposite surface 43 which is not protected by the third mask 84c, that is, the area opposite the opening 85 in the third mask 84c, is removed by ion milling or RIE to form a groove of a predetermined depth. The third mask 84c is subsequently removed. Thus, as shown in FIG. 15, the intermediate portion of the side step 46 is partly removed to form a thin protruding portion 46a having a width of 30 μm or less. The protruding portion 46a has two opposite sides adjacent to respective grooves of different depths.

The method of manufacturing the head configured as described above and this magnetic head make it possible to exert effects similar to those of the above first embodiment.

Now, description will be given of a magnetic head in HDD according to a third embodiment of the present invention.

As shown in FIG. 17, according to the third embodiment, a leading step 50, pair of side steps 46, and trailing step 60 are formed on the disk opposite surface 43 of the slider 42; the leading step 50, pair of side steps 46, and trailing step 60 each constitute a protrusion. The leading pad 52, side pad 48, and trailing pad 66 are formed on the leading step 50, side step 46, and trailing step 60, respectively.

The trailing step 60 is provided with a rectangular recessed portion 60b that is open toward the negative pressure cavity 54 and a pair of elongate protruding portions 60a positioned on the opposite sides of the recessed portion 60b along the second direction Y. Each protruding portion 60a has two sides extending in the first direction X and opposite each other. These two sides are formed by subjecting the disk opposite surface 43 to removing processing and are adjacent to respective grooves of different depths. The width of each protruding portion 60a is formed to be 30 μm or less, for example, which is smaller than the minimum width of a mask used for a removing process.

In the third embodiment, the other arrangements of the magnetic head are the same as those in the first embodiment. The same parts are denoted by the same reference numerals and their detailed description is omitted.

Now, description will be given of a method of manufacturing a magnetic head configured as described above, here, a method of forming the disk opposite surface 43 of the slider 42 into a desired recessed and protruding shape.

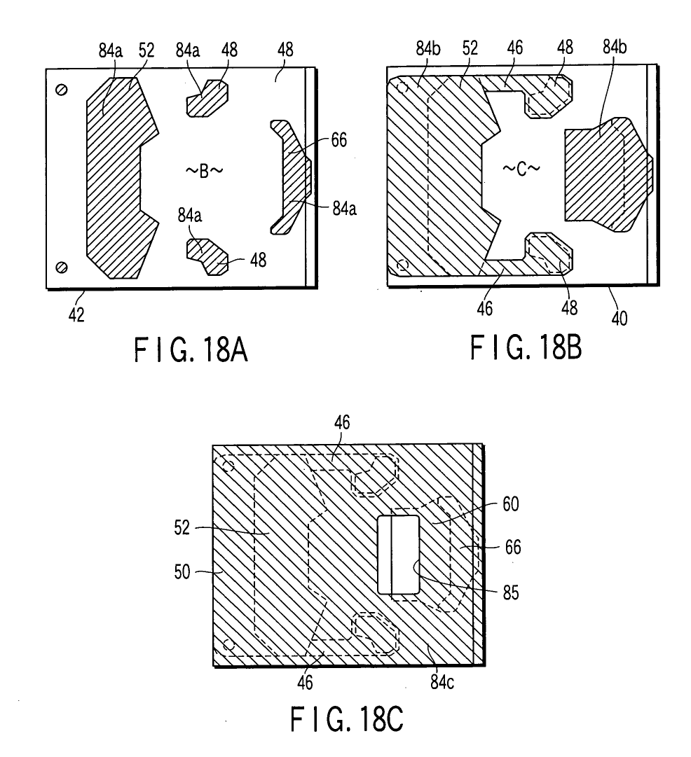

As is the case with the first embodiment, as shown in FIG. 18A, the first mask 84a is formed on the disk opposite surface 43 of the slider 42; the first mask 84a has a shape corresponding to the leading pad 52, side pad 48, and trailing pad 66. The area B of the disk opposite surface 43 which is not protected by the first mask 84a is removed by ion milling or RIE. The first mask 84a is subsequently removed. This forms a leading pad 52, side pads 48, and a trailing pad 66 on the disk opposite surface 43.

Subsequently, as shown in FIG. 18B, the second mask 84b is formed on the disk opposite surface 43 of the slider 42; the second mask 84b has a shape corresponding to the leading step 50, pair of side steps 46, and trailing step 60. The width of smallest part of the second mask 84b is formed to be sufficiently larger than 30 μm. Under these conditions, the area C of the disk opposite surface 43 which is not protected by the second mask 84b is removed by ion milling or RIE. The second mask 84b is subsequently removed. This forms a leading step 50, a pair of side steps 46, a trailing step 60, and a negative pressure cavity 54.

Then, third removing processing is executed to form a recessed portion 60b and an elongate protruding portion 60a in the trailing step 60. In this case, as shown in FIG. 18C, the third mask 84c is formed which covers the entire disk opposite surface 43 of the slider 42. A rectangular opening 85 is formed in the third mask 84c. The opening 85 is located opposite one side of the trailing step 60 facing the negative pressure cavity 54 and also opposite a part of the trailing step 60 in the width direction. Thus, the third mask 84c covers a part of the trailing step 60 which corresponds to two sides of it extending in the first direction X and to its area of width of 30 μm or less.

Under these conditions, an area of the disk opposite surface 43 which is not protected by the third mask 84c, that is, the area opposite the opening 85 in the third mask 84c, is removed by ion milling or RIE to form a groove of a predetermined depth. The third mask 84c is subsequently removed. Thus, as shown in FIG. 17, the trailing step 60 is partly removed to form a pair of elongate protruding portions 60a having a width of 30 μm or less. Each of the protruding portions 60a has two opposite sides adjacent to respective grooves of different depths.

The method of manufacturing the head configured as described above and this magnetic head make it possible to exert effects similar to those of the above first embodiment. Further, the third embodiment forms a recessed portion 60b and a pair of protruding portions 60a on the flow-in side of the trailing step 60; the protruding portions collect air currents in the trailing pad portion. This makes it possible to increase a positive pressure generated by the trailing step. It is also possible to increase the area of the negative pressure cavity 54, which generates a negative pressure. Therefore, a magnetic head with excellent characteristics can be provided.

Now, description will be given of a magnetic head in HDD according to a fourth embodiment of the present invention.

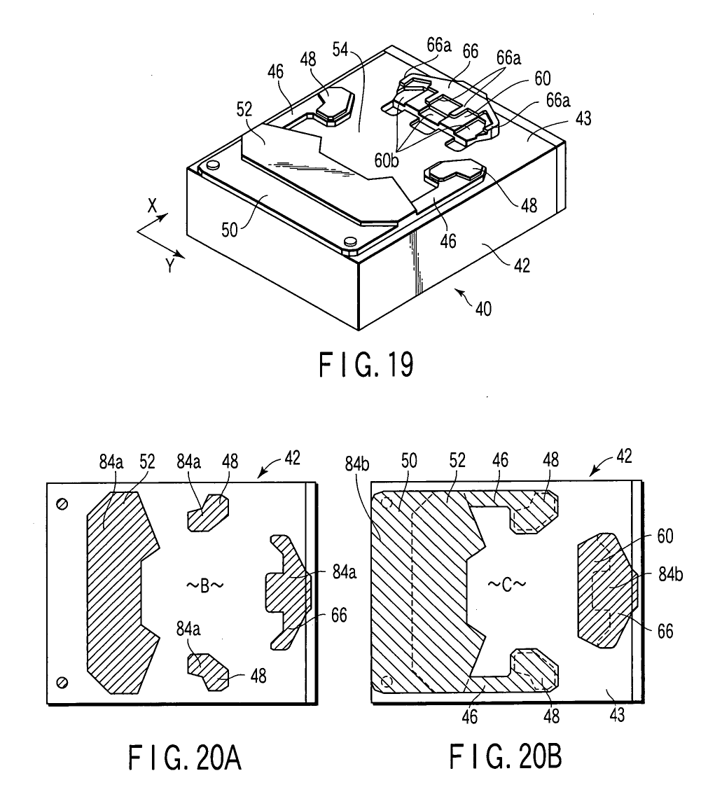

As shown in FIG. 19, according to the fourth embodiment, a leading step 50, pair of side steps 46, and trailing step 60 are formed on the disk opposite surface 43 of the slider 42; the leading step 50, pair of side steps 46, and trailing step 60 each constitute a protrusion. The leading pad 52, side pad 48, and trailing pad 66 are formed on the leading step 50, side step 46, and trailing step 60, respectively.

The trailing step 60 is provided with a plurality of, for example, three rectangular recessed portion 60b that are open toward the negative pressure cavity 54 and a plurality of, for example, four elongate protruding portions 66a extending from the trailing pad 66 to the negative pressure cavity 54. Each protruding portion 66a has two sides extending in the first direction X and opposite each other. These two sides are formed by subjecting the disk opposite surface 43 to removing processing and are adjacent to respective grooves of different depths. The width of each protruding portion 66a is formed to be 30 μm or less, for example, which is smaller than the minimum width of a mask used for a removing process.

In the fourth embodiment, the other arrangements of the magnetic head are the same as those in the first embodiment. The same parts are denoted by the same reference numerals and their

Now, description will be given of a method of manufacturing a magnetic head configured as described above, here, a method of forming the disk opposite surface 43 of the slider 42 into a desired recessed and protruding shape.

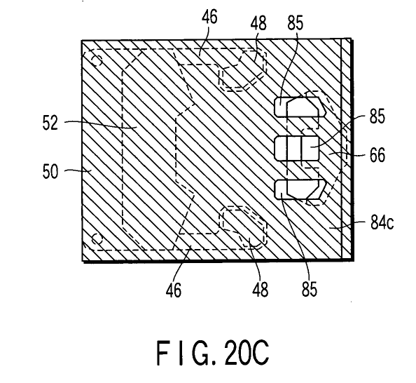

As is the case with the first embodiment, as shown in FIG. 20A, the first mask 84a is formed on the disk opposite surface 43 of the slider 42; the first mask 84a has a shape corresponding to the leading pad 52, side pad 48, and trailing pad 66. The area B of the disk opposite surface 43 which is not protected by the first mask 84a is removed by ion milling or RIE. The first mask 84a is subsequently removed. This forms a leading pad 52, side pads 48, and a trailing pad 66 on the disk opposite surface 43.

Subsequently, as shown in FIG. 20B, the second mask 84b is formed on the disk opposite surface 43 of the slider 42; the second mask 84b has a shape corresponding to the leading step 50, pair of side steps 46, and trailing step 60. The width of smallest part of the second mask 84b is formed to be sufficiently larger than 30 μm. Under these conditions, the area C of the disk opposite surface 43 which is not protected by the second mask 84b is removed by ion milling or RIE. The second mask 84b is subsequently removed. This forms a leading step 50, a pair of side steps 46, a trailing step 60, and a negative pressure cavity 54.

Then, third removing processing is executed to form three recessed portions 60b and an elongate protruding portion 60a in the trailing step 60. In this case, as shown in FIG. 20C, the third mask 84c is formed which covers the entire disk opposite surface 43 of the slider 42. Three rectangular openings 85 are formed in the third mask 84c in parallel in the second direction Y. Each opening 85 is located opposite one side of the trailing step 60 facing the negative pressure cavity 54 and also opposite a part of the trailing step 60 in the width direction. The opening 85 is also located opposite one side of the trailing pad 66 facing the negative pressure cavity 54 and also opposite a part of the trailing step 66 in the width direction. Thus, the third mask 84c covers a part of the trailing step 60 and a part of the trailing pad 66.

Under these conditions, an area of the disk opposite surface 43 which is not protected by the third mask 84c, that is, the area opposite the opening 85 in the third mask 84c, is removed by ion milling or RIE to form a groove of a predetermined depth. The third mask 84c is subsequently removed. Thus, as shown in FIG. 19, the trailing step 60 is partly removed to form three recessed portions 60b. At the same time, the trailing pad 66 is partly removed to form four elongate protruding portions 66a having a width of 30 μm or less. Each of the protruding portions 66a has two opposite sides adjacent to respective grooves of different depths.

The method of manufacturing the head configured as described above and this magnetic head make it possible to exert effects similar to those of the above first embodiment. Further, the fourth embodiment forms a plurality of recessed portion 60b and a plurality of protruding portions 66a on the flow-in side of the trailing step 60; the protruding portions collect air currents in the trailing pad portion. This makes it possible to increase a positive pressure generated by the trailing step. It is also possible to increase the area of the negative pressure cavity 54, which generates a negative pressure. Therefore, a magnetic head with excellent characteristics can be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the shapes of the protruding and recessed portions formed on the disk opposite surface of the slider are not limited to rectangles. The protruding and recessed portions may have various shapes. The present invention is applicable not only to pico sliders, pemto sliders, and femto sliders but also to larger sliders. Moreover, the present invention is applicable not only to the above floating type slider but also to a contact type head having a recording element that contacts the surface of a recording medium.

What is claimed is:

1. A method of manufacturing a head comprising a slider including an opposite surface which is opposite a surface of a rotatable recording medium and which has a plurality of protrusions and a negative pressure cavity, the slider being configured to maintain a fixed gap between the opposite surface and the recording medium surface by air currents generated between the recording medium surface and the opposite surface by rotation of the recording medium, and a head portion provided on the slider to read and record information from and in the recording medium, the method comprising:
providing a mask having a predetermined shape on the opposite surface of the slider and then subjecting the opposite surface to removing processing to form a protrusion including a protruding portion having two opposite sides; and
providing another mask on the opposite surface of the slider, the another mask covering one of the two opposite sides and a part of the protruding portion, and then subjecting the opposite surface to removing processing to form a protruding portion in which the two opposite sides are adjacent to respective grooves of different depths and which is narrower than the narrowest part of the masks used.

2. A head manufactured by the manufacturing method according to claim 1, the head comprising:
a slider having the opposite surface;
a leading step and a pair of side steps formed on the opposite surface of the slider, each constituting the protrusion; and
a negative pressure cavity defined by the leading step and pair of side steps,
an end portion of each of the side steps which is positioned downstream with respect to the air currents constituting the protruding portion.

3. A head manufactured by the manufacturing method according to claim 1, the head comprising:
a slider having the opposite surface;
a leading step and a pair of side steps formed on the opposite surface of the slider, each constituting the protrusion, and side pads protrusively formed on the respective side steps; and
a negative pressure cavity defined by the leading step and pair of side steps,
an intermediate portion of each of the side steps which is positioned between the leading step and the side pad constituting the protruding portion.

4. A head manufactured by the manufacturing method according to claim 1, the head comprising:
a slider having the opposite surface;
a leading step, a pair of side steps, and a trailing step formed on the opposite surface of the slider and each constituting the protrusion, a trailing pad protrusively formed on the trailing step; and
a negative pressure cavity defined by the leading step and pair of side steps,
the trailing step including a recessed portion which is open toward the negative pressure cavity, and the protruding portion positioned in parallel with the recessed portion and extending toward the negative pressure cavity.

5. A head manufactured by the manufacturing method according to claim 1, the head comprising:
a slider having the opposite surface;
a leading step, a pair of side steps, and a trailing step formed on the opposite surface of the slider and each constituting the protrusion, a trailing pad protrusively formed on the trailing step; and
a negative pressure cavity defined by the leading
step and pair of side steps, the trailing step having protruding portions each extending toward the negative pressure cavity.

6. A disk driving device comprising:
a disk-shaped recording medium;
a driving section which supports and rotates the recording medium;
the head according to claim 2 comprising a slider including an opposite surface which is opposite a surface of the recording medium and which maintains a fixed gap between the opposite surface and the recording medium surface via air currents generated between the recording medium surface and the opposite surface by rotation of the recording medium, and a head portion provided in the slider to record and reproduce information on and from the recording medium; and
a head suspension which supports the head so that the head is movable with respect to the recording medium and which imposes a head load acting toward the surface of the recording medium, on the head.

7. A disk driving device comprising:
a disk-shaped recording medium;
a driving section which supports and rotates the recording medium;
the head according to claim 3 comprising a slider having an opposite surface which is opposite a surface of the recording medium and which maintains a fixed gap between the opposite surface and the recording medium surface via air currents generated between the recording medium surface and the opposite surface by rotation of the recording medium, and a head portion provided on the slider to record and reproduce information on and from the recording medium; and
a head suspension which supports the head so that the head is movable with respect to the recording medium and which imposes a head load acting toward the surface of the recording medium, on the head.

8. A disk driving device comprising:
a disk-shaped recording medium;
a driving section which supports and rotationally drives the recording medium;
the head according to claim 4 comprising a slider having an opposite surface which is opposite a surface of the recording medium and which maintains a fixed gap between the opposite surface and the recording medium surface via air currents generated between the recording medium surface and the opposite surface by rotation of the recording medium, and a head portion provided on the slider to record and reproduce information on and from the recording medium; and
a head suspension which supports the head so that the head is movable with respect to the recording medium and which imposes a head load acting toward the surface of the recording medium, on the head.

9. A disk driving device comprising:
a disk-shaped recording medium;
a driving section which supports and rotates the recording medium;
the head according to claim 5 comprising a slider having an opposite surface which is opposite a surface of the recording medium and which maintains a fixed gap between the opposite surface and the recording medium surface via air currents generated between the recording medium surface and the opposite surface by rotation of the recording medium, and a head portion provided in the slider to record and reproduce information on and from the recording medium; and
a head suspension which supports the head so that the head is movable with respect to the recording medium and which imposes a head load acting toward the surface of the recording medium, on the head.
